(19) United States
(12) Patent Application Publication
(10) Pub. No.: US 2008/0192968 A1
(43) Pub. Date: Aug. 14, 2008

(54) Hearing apparatus with automatic alignment of the directional microphone and corresponding method

(76) Inventors: Wai Kit David Ho, Singapore (SG); Wee Haw Koo, Singapore (SG); Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/012,751

(22) Filed: Feb. 5, 2008

(30) Foreign Application Priority Data
Feb. 6, 2007 (DE) 10 2007 005 861.8

(51) Int. Cl. H04R 25/00

(52) U.S. Cl. 381/313

(57) ABSTRACT

The hearing comfort when wearing hearing apparatuses is to be improved. To this end, a hearing apparatus and in particular a hearing device is proposed, which has a directional microphone with a preferred direction of recording sound. Furthermore, the hearing apparatus has an inclination determination facility, for determining an inclination of the preferred direction of recording sound in respect of the absolute horizontal for instance. An alignment unit then provides for the directional microphone to be aligned as a function of the determined inclination. The directional microphone of a hearing device can thus always be aligned horizontally independently of the movement of the head of a hearing device wearer.

### CROSS REFERENCE TO RELATED APPLICATIONS

This application claims priority of German application No. 10 2007 005 861.8 filed Feb. 6, 2007, which is incorporated by reference herein in its entirety.

### FIELD OF THE INVENTION

The present invention relates to a hearing apparatus with a directional microphone, which has a preferred direction of recording sound. The present invention also relates to a corresponding method for operating a hearing apparatus. The term hearing apparatus is understood here to mean in particular a hearing device, but also a headset or earphones.

### BACKGROUND OF THE INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including conch hearing devices or channel hearing devices (CIC), are provided. The hearing devices designed by way of example are worn on the outer ear or in the auditory canal. Furthermore, bone conduction hearing aids, implantable or vibrotactile hearing aids are also available on the market. The damaged hearing is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Hearing devices with a directional microphone require at least two microphones. The signals of the number of microphones are linked to one another such that the desired directional characteristics are produced. These directional characteristics nevertheless also depend on the characteristics of the individual microphones and their spatial arrangement in respect of one another.

It is generally desirable for hearing device wearers if the directional characteristics of the directional microphone are aligned horizontally. This is however not always possible as a function of the wearing position of the hearing devices.

Attempts have hitherto been made to arrange the microphones as horizontally as possible in respect of each other. This thus generally produces a preferred direction of recording sound for the hearing device user in the horizontal direction forwards. If, however, the hearing device wearer briefly fails to see his/her conversational partner, if he bends his/her head toward the table for instance, the preferred direction of recording sound of the directional microphone also points to the table and no longer to the conversational partner. This may result in the hearing quality being adversely affected.

The publication DE 102005017496 B3 discloses a microphone facility with an orientation sensor. It can thus be controlled as a function of the orientation and can be switched into directional operation for instance if it is aligned horizontally. With a vertical alignment, the directional microphone is automatically switched into omnidirectional mode for instance.

The publication DE 102005006660 B3 also discloses a method for adjusting a hearing aid device. In this process, information relating to an alignment of the hearing device in two or three dimensions can be taken into account as additional information during the adjustment of a parameter. In particular, the alignment of the hearing device can be measured by means of a compass or an inclination sensor.

### SUMMARY OF THE INVENTION

The object of the present invention thus consists in improving the control of the directional characteristics of a directional microphone to the effect that the hearing quality increases. In accordance with the invention, this object is achieved by a hearing apparatus having a directional microphone, which comprises a preferred direction of recording sound, as well as an inclination determination device for determining an inclination of the preferred direction of recording sound in respect of a fixed direction which is predetermined with regard to the surroundings of a hearing apparatus and an alignment unit, with which the preferred direction of recording sound of the directional microphone can be aligned as a function of the determined inclination.

In accordance with the invention, a method for operating a hearing apparatus with a directional microphone is also provided, which has a preferred direction of recording sound, by determining an inclination of the preferred direction of recording sound in respect of a fixed direction which is predetermined with regard to the surroundings of the hearing apparatus and aligning the preferred direction of recording sound of the directional microphone as a function of the determined inclination.

A direction, to which the hearing apparatus orientates when aligning the directional microphone, is thus advantageously predetermined from the outside. A hearing device wearer is then thus able to better perceive the sound source of interest, even if he/she does not align his/her head thereto. The alignment of the directional microphone can either be carried out in a software-specific and/or signal-specific fashion or also by physically aligning the individual microphones and/or a microphone array.

The inclination determination device preferably includes a gyroscope. The gyroscopic effect can be used in this way, which effects an automatic control of the rotating gyroscope. Inertia wheels or gyroscopes of this type are known from spacecraft in order to change the angular motion. The rotating system restores a stable state even in the case of interferences.

However, the inclination determination device can also use a liquid surface to determine the inclination. The gravitation is used here as the external force, which always provides for a horizontal liquid surface.

It has proven particularly advantageous for the alignment unit to always align the preferred direction of recording sound horizontally in the direction of the directional microphone. As a result, the directional microphone can be aligned in a targeted fashion precisely in the event of conversations.

The directional microphone favorably has at least two microphones, which are aligned such that the preferred direction of recording sound points horizontally forwards in the direction of the directional microphone when being worn in a usual position. The directional characteristics are improved if the directional microphone has three or more microphones.

### BRIEF DESCRIPTION OF THE DRAWINGS

The present invention is described in more detail with reference to the appended drawings, in which:

FIG. 1 shows a basic diagram of the design of a hearing device according to the prior art;

FIG. 2 shows a basic diagram of the design of a hearing device according to the invention;

FIG. 3 shows a diagram of a gyroscopic stabilizer.

### DETAILED DESCRIPTION OF THE INVENTION

The exemplary embodiments illustrated in more detail below represent preferred embodiments of the present invention.

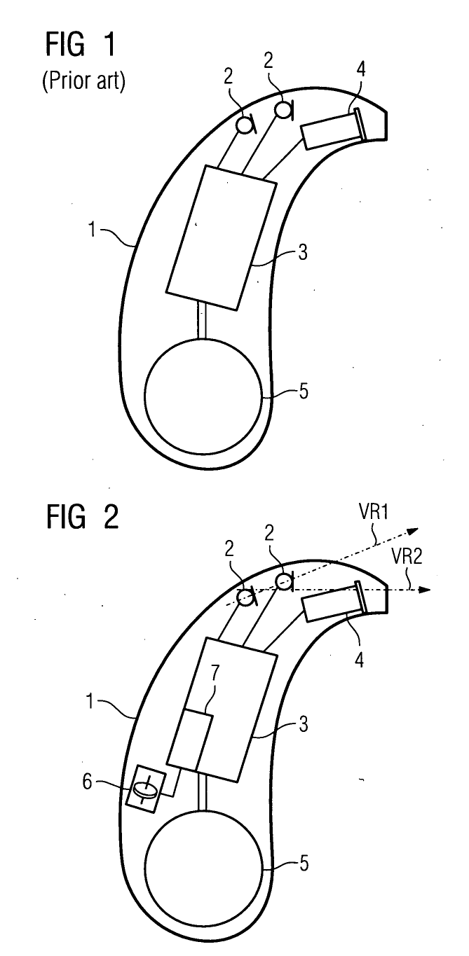

The hearing device illustrated by way of example in FIG. 2 essentially has the same design as the hearing device in FIG. 1. An inclination determination device, here a gyroscope 6, is however also provided in the hearing device. The gyroscope 6 always provides a constant direction, even if the hearing device is tilted, inclined or moved otherwise.

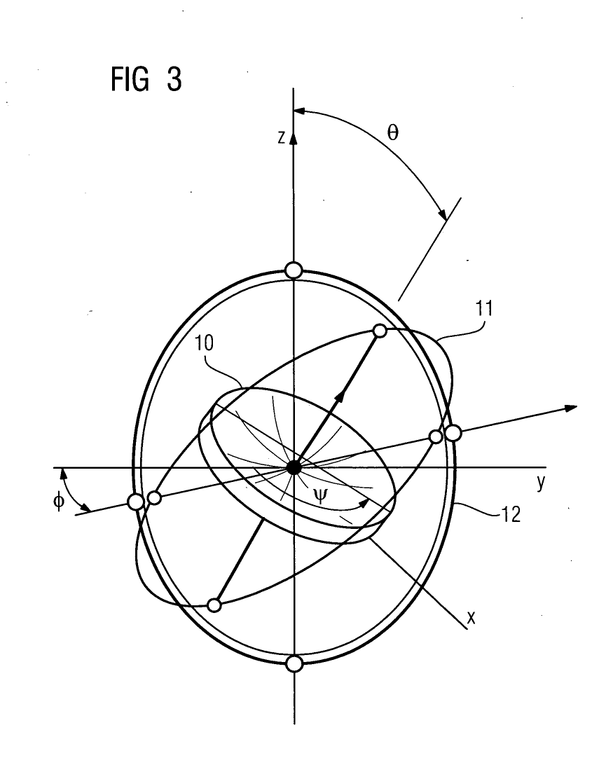

FIG. 3 shows a gyroscopic stabilizer of this type. A gyroscope 10 is rotatably mounted in a first ring 11 with its axes. This is in turn mounted in a second ring 12, so that the axis of rotation of the gyroscope 10 can adopt any arbitrary spatial direction in the usual manner of a gyroscope. The inclination determination device 6 then determines the corresponding angles Φ, Θ and Ψ in respect of the main axes x, y and z.

Instead of the gyroscope 6, a type of ‘water level’ can also be used. This always allows the absolute horizontal to be determined as the fixed direction which is predetermined in respect of the surroundings of the hearing apparatus.

An alignment unit 7 is integrated into the signal processing device 3 of the hearing device. Said alignment unit allows the directional characteristics of the two microphones 2, with which a directional microphone is formed, to be adjusted. In the example in FIG. 2, the preferred direction of recording sound VR1 firstly lies on the straight line for instance, which is determined by the center points of the microphone. If the inclination determination device, here the gyroscope 6, now establishes that the device has inclined, the preferred direction of recording sound can be correspondingly corrected so that the direction VR2 results. The preferred direction of recording sound would then be aligned horizontally again and the hearing device wearer could then perceive the horizontally incident sound at its best. In order to correct the directional characteristics of the directional microphone, the alignment unit 7 assumes the corresponding angle/s of the gyroscope 6 and/or ‘water level’, as a result of which the new directional characteristics can be determined in a computational fashion and can be used for the subsequent signal processing.

Alternatively or in addition, the microphones 2 of the directional microphone can also actually be adjusted in terms of their physical alignment by means of a miniature adjuster. This herewith also allows the directional characteristics to be influenced in respect of a certain range.

Automatically aligning the directional microphone dispenses with the need for the hearing device wearer to accordingly adjust the hearing device when moving his/her head or to always align his/her head horizontally toward the sound source for instance. The hearing device wearer is thus freer in terms of his/her movements and finds the sound perception process more natural.

1.-8. (canceled)

9. A hearing apparatus, comprising:
a directional microphone that comprises a preferred direction of recording sound;
an inclination determination device that determines an inclination of the preferred direction of recording sound in respect of a fixed direction; and
an alignment unit that aligns the preferred direction of recording sound as a function of the inclination.

10. The hearing apparatus as claimed in claim 9, wherein the inclination determination device comprises a gyroscope.

11. The hearing apparatus as claimed in claim 9, wherein the inclination determination device determines the inclination using a liquid surface.

12. The hearing apparatus as claimed in claim 9, wherein the alignment unit horizontally aligns the preferred direction of recording sound.

13. The hearing apparatus as claimed in claim 9, wherein the directional microphone comprises at least two microphones.

14. The hearing apparatus as claimed in claim 9, wherein the fixed direction is predetermined with regard to a surrounding of the hearing apparatus.

15. A method for operating a hearing apparatus having a directional microphone, comprising:
determining an inclination of a preferred direction of recording sound of the directional microphone in respect of a fixed direction; and
aligning the preferred direction of recording sound of the directional microphone as a function of the inclination.

16. The method as claimed in claim 15, wherein the inclination is determined by a gyroscope.

17. The method as claimed in claim 15, wherein the inclination is determined by a liquid surface.

18. The method as claimed in claim 15, wherein the preferred direction of recording sound of the directional microphone is aligned horizontally.

19. The method as claimed in claim 15, wherein the fixed direction is predetermined with regard to a surrounding of the hearing apparatus.
